(19) United States
(12) Patent Application Publication
(10) Pub. No.: US 2026/0365267 A1
(43) Pub. Date: Nov. 19, 2026

(54) Saddle-Ride Vehicle

(71) Applicant: HONDA MOTOR CO., LTD., TOKYO (JP)

(72) Inventors: Jun NAKANO, TOKYO (JP); Akihiko MATSUKAWA, TOKYO (JP); Takeshi SAKAI, TOKYO (JP)

(21) Appl. No.: 19/675,755

(22) Filed: May 13, 2026

(30) Foreign Application Priority Data
May 16, 2025 (JP) 2025-082670

(51) Int. Cl. B62J 40/00; B62J 17/10

(52) U.S. Cl. CPC B62J 40/00; B62J 17/10

(57) ABSTRACT

A saddle-ride vehicle includes: an air cleaner device, which constitutes a part of a power unit intake system; and a side cover, which covers at least a part of the air cleaner device from one side in a vehicle width direction, in which the air cleaner device includes: a case, inside of which is hollow; and an element disposed in the case, and a case-side opening portion, which opens a space on an intake side of the element, is provided on a side wall on one side in the vehicle width direction of the case, and the side cover includes a cover-side opening portion, which faces at least a part of the case-side opening portion, and a rear region of the cover-side opening portion serves as a closure portion, which faces at least a part of the case-side opening portion.

### INCORPORATION BY REFERENCE

The present application claims priority under 35 U.S.C.§119 to Japanese Patent Application No. 2025-082670 filed on May 16, 2025. The content of the application is incorporated herein by reference in its entirety.

### BACKGROUND

### Technical Field

The present invention relates to a saddle-ride vehicle.

### Related Art

In a saddle-ride vehicle such as a motorcycle, an air cleaner device that constitutes a part of a power unit intake system is disposed below a seat (see, for example, WO 2015/033425 A). WO 2015/033425 A describes a motorcycle having a configuration in which the air cleaner device is disposed below the seat and a large-sized opening portion is provided on an upper side of an air cleaner case. In this configuration, it is necessary to provide a gap between the air cleaner case and the seat. Hence, the seat height is increased, or it is necessary to reduce the volume of the air cleaner case in order to reduce the seat height.

### SUMMARY

In the air cleaner device, by the way, it is necessary to periodically carry out maintenance of an element for cleaning air. In the conventional configuration, a large-sized component such as the seat has to be detached at the time of carrying out maintenance of the element, and improvement in maintenance capability is still insufficient.

The present invention has been made in view of the above circumstances, and it is an object of the present invention to improve maintenance capability of an air cleaner device, while efficiently taking outside air into the air cleaner device.

In order to achieve the above object, a saddle-ride vehicle includes: an air cleaner device, which constitutes a part of a power unit intake system; and a side cover, which covers at least a part of the air cleaner device from one side in a vehicle width direction, in which the air cleaner device includes: a case, inside of which is hollow; and an element disposed in the case, and a case-side opening portion, which opens a space on an air intake side of the element, is provided on a side wall on one side in the vehicle width direction of the case, and the side cover includes a cover-side opening portion, which faces at least a part of the case-side opening portion, and a rear region of the cover-side opening portion serves as a closure portion, which faces at least a part of the case-side opening portion.

According to an aspect of the present invention, it becomes possible to improve maintenance capability of an air cleaner device while efficiently taking outside air into the air cleaner device.

### BRIEF DESCRIPTION OF DRAWINGS

FIG. 1 is a view illustrating a part of a side surface of a saddle-ride vehicle;

FIG. 2 is a view illustrating a state in which a side cover is detached from FIG. 1;

FIG. 3 is a cross-sectional view taken along line III-III of FIG. 2;

FIG. 4 is a perspective view illustrating an air cleaner device of FIG. 3 viewed from obliquely above;

FIG. 5 is an enlarged view of a region of the cover-side opening in FIG. 2;

FIG. 6 is an enlarged view of a region of the side cover in FIG. 1;

FIG. 7 is an enlarged view of main components of FIG. 2;

FIG. 8 is a perspective view illustrating a right surface of an air cleaner case together with a peripheral configuration;

FIG. 9 is a cross-sectional view taken along line IX-IX of FIG. 5;

FIG. 10 is an enlarged view of the periphery of an element in FIG. 9; and

FIG. 11 is a cross-sectional view taken along line XI-XI of FIG. 10.

### DETAILED DESCRIPTION

Hereinafter, embodiments of the present invention will be described with reference to the drawings. Note that in the description, directions such as front, rear, left, right, up, and down are identical to directions with respect to a vehicle body, unless otherwise specified. In the drawings, reference sign FR denotes the front of the vehicle body, reference sign UP denotes top of the vehicle body, and reference sign LH denotes left of the vehicle body.

### Embodiments

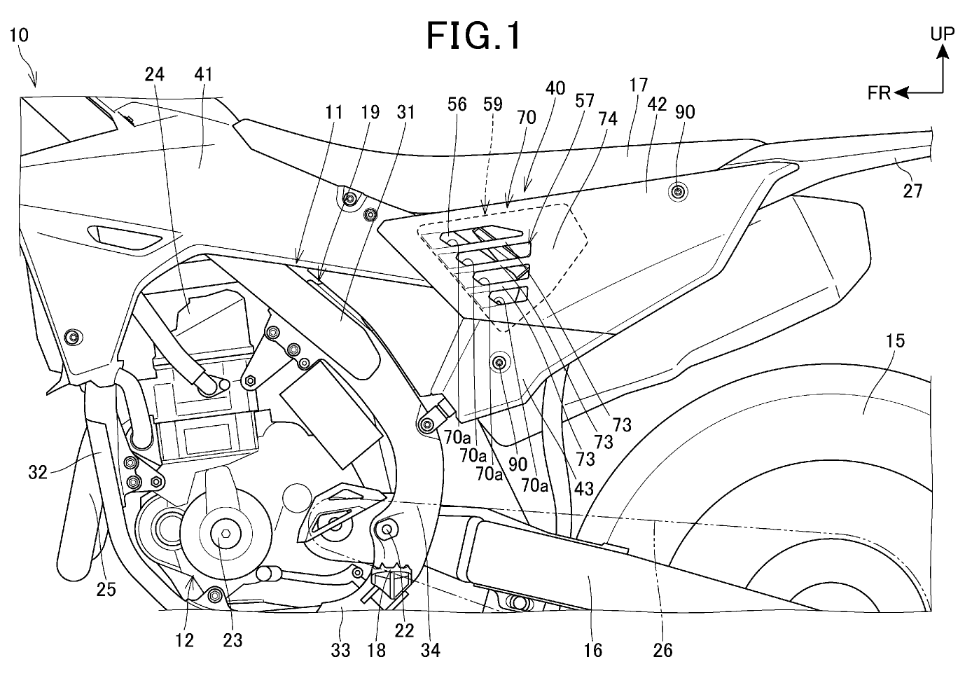

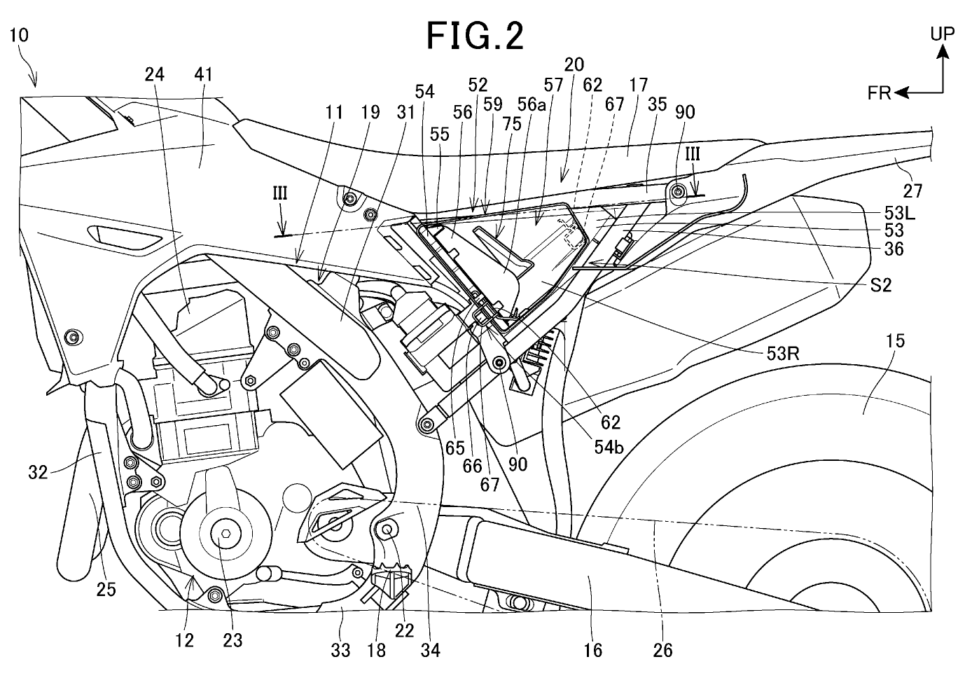

FIG. 1 is a view illustrating a part of a side surface of a saddle-ride vehicle 10. FIG. 2 is a view illustrating a state in which a side cover 42 is detached from FIG. 1.

The saddle-ride vehicle 10 is a vehicle including: a vehicle body frame 11; a power unit 12, which is supported by the vehicle body frame 11; a front fork, not illustrated, which supports a front wheel, not illustrated; a swing arm 16, which supports a rear wheel 15; and a seat 17 for an occupant.

In the present embodiment, the saddle-ride vehicle 10 is a motorcycle, and is an off-road vehicle.

The vehicle body frame 11 includes: a head pipe, not illustrated, which steerably supports the front wheel via the front fork; a front frame 19, which extends rearward from the head pipe; and a rear frame 20, which extends rearward from the front frame 19.

The seat 17 is supported on an upper portion of the rear frame 20.

A front end portion of the swing arm 16 is supported by a pivot shaft 22, which is supported by a rear lower portion of the front frame 19. The pivot shaft 22 is a shaft extending horizontally in a vehicle width direction. The swing arm 16 swings up and down with the pivot shaft 22 as the center.

As illustrated in FIG. 1, a step 18 on which the rider places his/her foot is provided below the pivot shaft 22.

The power unit 12 is supported by the vehicle body frame 11.

The power unit 12 is an internal combustion engine. The power unit 12 includes: a crankcase 23; and a cylinder unit 24, which accommodates a piston that reciprocates. An exhaust device 25 is connected with an exhaust port of the cylinder unit 24.

Output of the power unit 12 is transmitted to the rear wheel 15 by a driving force transmission member 26, which connects the power unit 12 with the rear wheel 15. An upper portion of the rear wheel 15 is covered with a rear fender 27.

In the present embodiment, the front frame 19 includes: a pair of left and right main frames 31, which extend rearward and downward from the head pipe; one down frame 32, which extends downward from the head pipe; a pair of left and right lower frames 33, which extend rearward from a lower end portion of the down frame 32; and a pair of left and right pivot frames 34, which extend downward from rear ends of the respective main frames 31 and are connected with the lower frames 33.

The rear frame 20 includes: a pair of left and right seat frames 35, which extend rearward from the respective front frames 19; and a pair of left and right rear sub frames 36, which extend rearward and upward from intermediate portions in a longitudinal direction of the respective pivot frames 34 and are connected with intermediate portions in a longitudinal direction of the seat frames 35.

As illustrated in FIG. 1, the saddle-ride vehicle 10 includes a vehicle body cover 40, which covers the vehicle body including the vehicle body frame 11 and the like. The vehicle body cover 40 includes: a pair of left and right shrouds 41, which cover the front frame 19 from lateral sides; a pair of left and right side covers 42, which cover the seat frame 35 from lateral sides on the rear of the shrouds 41; and a sub cover 43, which covers lateral sides of the rear sub frames 36 below the shrouds 41 and the side covers 42. In the present embodiment, the side cover 42 is detachably held onto the vehicle body frame 11 with a fixing member 90 such as a bolt or a rivet.

A throttle body, not illustrated, is connected with a back surface of the cylinder unit 24, and an air cleaner device 52 is connected with a rear end of the throttle body. The throttle body and the air cleaner device 52 constitute a power unit intake system.

The air cleaner device 52 is disposed below the seat 17 and between the left and right seat frames 35 and the left and right rear sub frames 36.

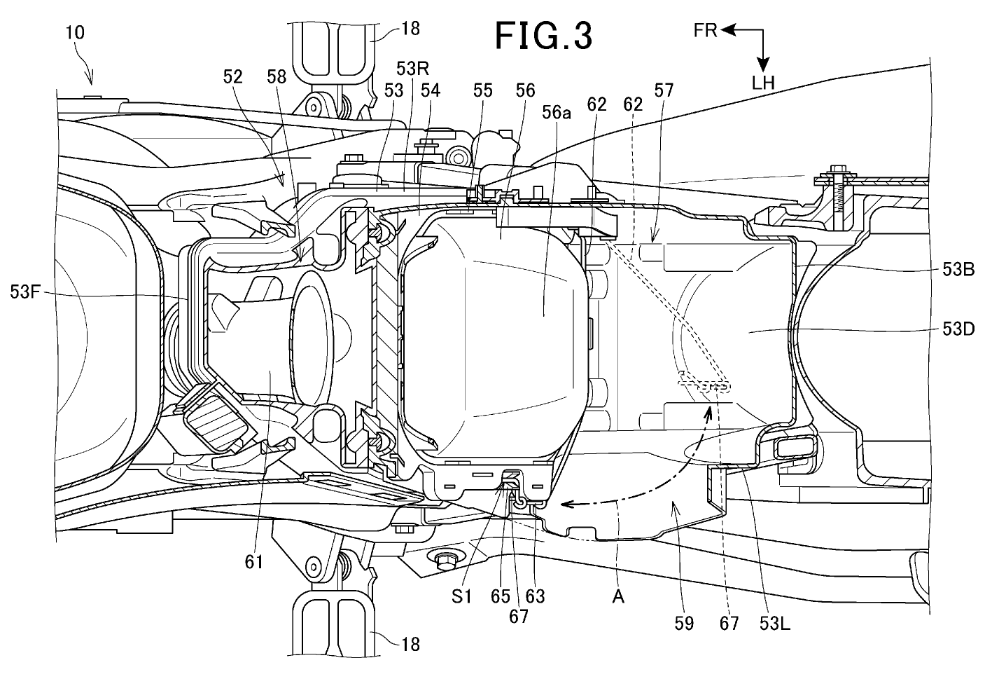

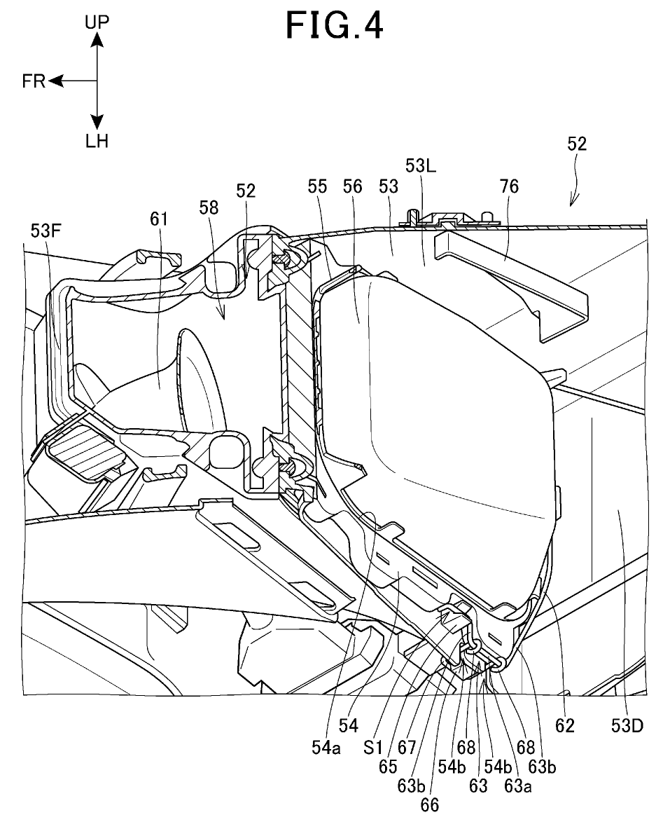

FIG. 3 is a cross-sectional view taken along line III-III of FIG. 2. FIG. 4 is a perspective view illustrating the air cleaner device 52 in FIG. 3 viewed from obliquely above.

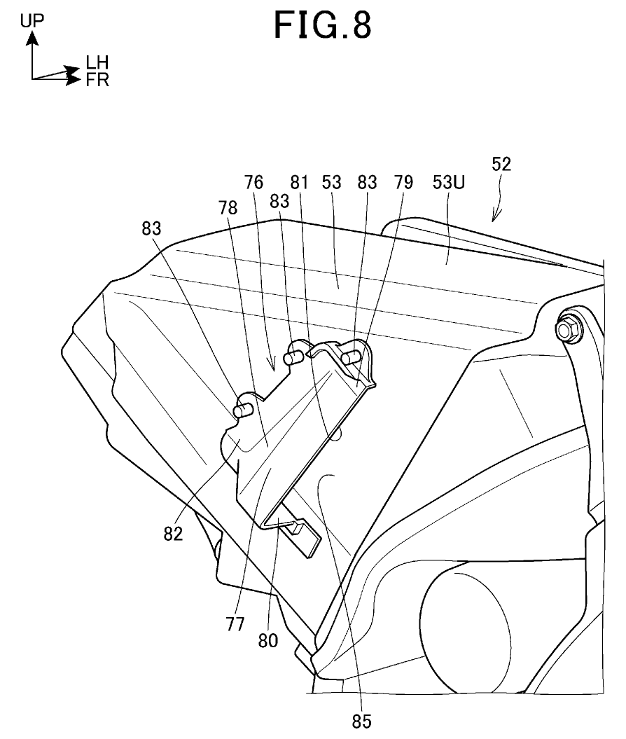

The air cleaner device 52 includes an air cleaner case (case) 53, the inside of which is hollow. The air cleaner case 53 includes: a bottom wall 53D, which forms a bottom surface of the air cleaner case 53; a right side wall 53R and a left side wall 53L, which are respectively provided on the right and left of the bottom wall 53D; a front wall 53F and a rear wall 53B, which are respectively provided on the front and rear of the bottom wall 53D; and a top wall 53U, which covers a top portion (see FIG. 8).

The top wall 53U overlaps the seat frame 35 in a side view of the vehicle body. The bottom wall 53D overlaps the rear sub frame 36 in the side view of the vehicle body.

Although details will be described later, a case-side opening portion 59, which occupies the most part of a rear portion of the left side wall 53L, is formed in a rear portion of the left side wall 53L of the air cleaner case 53. In addition, an auxiliary intake opening portion 75, which is smaller than the case-side opening portion 59, is formed in an intermediate portion of the right side wall 53R of the air cleaner case 53.

The air cleaner case 53 includes, in its inside, a separate plate 54, which partitions the air cleaner case 53 into a clean side 58 on the front and a dirty side 57 on the rear. An opening 54a, through which the clean side 58 and the dirty side 57 communicate with each other, is formed in the separate plate 54.

Furthermore, an element holder 55 is supported on a surface, which is closer to the dirty side 57, of the separate plate 54. An element 56 is detachably supported by the element holder 55 so as to cover the opening 54a.

The element 56 is a filter that removes foreign matters such as dust contained in the air flowing into the clean side 58 from the dirty side 57 through the opening 54a.

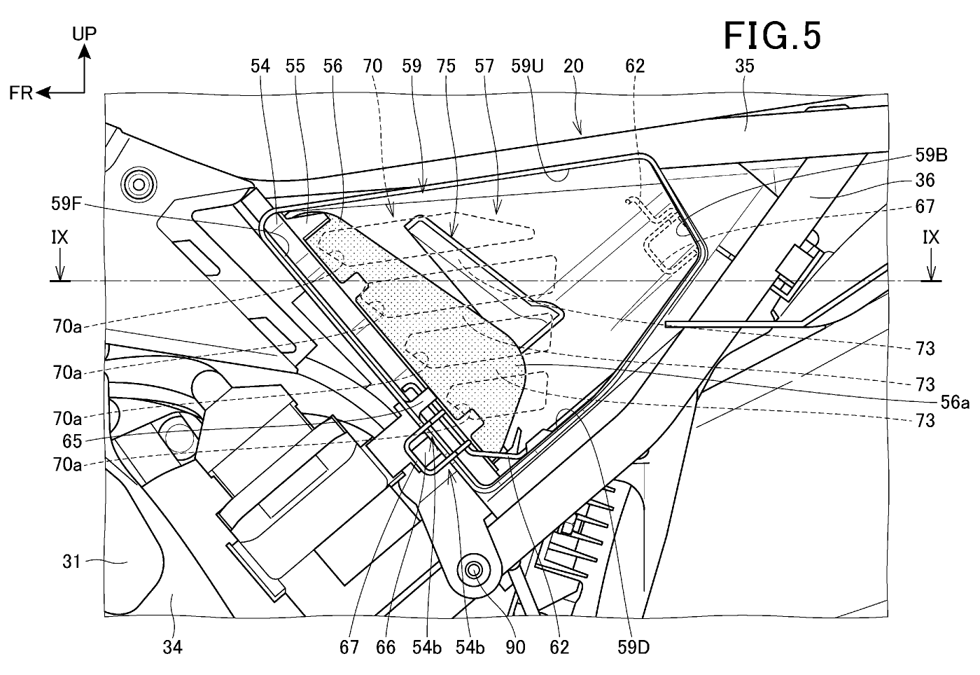

FIG. 5 is an enlarged view of a region of a cover-side opening portion 70 in FIG. 2, and is a view illustrating the cover-side opening portion 70 by a broken line.

On the air cleaner case 53, the case-side opening portion 59 is formed on the rear of the separate plate 54 in a side view of the vehicle body. The case-side opening portion 59 is formed on a side wall of the air cleaner case 53 on one side in the vehicle width direction. In the present embodiment, the case-side opening portion 59 is formed on a wall surface on the left of the air cleaner case 53, and is disposed in a space S2, which is defined by the pivot frame 34, the seat frame 35, and the rear sub frame 36 in the side view of the vehicle body. In addition, the case-side opening portion 59 is formed outside the seat frame 35 and the rear sub frame 36 in a top view of the vehicle body.

The case-side opening portion 59 is formed over the most part of the dirty side 57 in a side view of the vehicle body. This easily ensures an intake air amount of outside air from the case-side opening portion 59 to the dirty side 57.

In the present embodiment, the case-side opening portion 59 is formed in a substantially rectangular shape. Specifically, a front edge 59F linearly extends rearward and downward along the separate plate 54. An upper edge 59U extends linearly rearward and upward, partially overlapping the seat frame 35. A lower edge 59D extends rearward and upward along the rear sub frame 36. A rear edge 59B is positioned further on the front than a rear end of the air cleaner case 53 in the side view of the vehicle body.

Each of the edges 59F, 59U, 59D, 59B is provided with a seal, not illustrated. The seal is provided over the entire circumference of each of the edges 59F, 59U, 59D, and 59B except for an installation position of a holding tool 62 to be described later. In addition, in the present embodiment, the seal is provided to avoid an operation portion holding recess portion 54b to be described later. When covered with the side cover 42, the case-side opening portion 59 of the air cleaner case 53 is sealed by a seal.

The element 56 is formed in a bulge shape that protrudes rearward toward the dirty side 57. More specifically, the element 56 is formed in a trapezoidal shape that protrudes rearward toward its rear bottom in the side view of the vehicle body. A rear lower region that protrudes rearmost in the element 56 will be referred to as a “bulge portion 56a”. Thus, while sufficiently ensuring the surface area and the volume of the bulge portion 56a, it becomes possible to sufficiently ensure a separation distance between the bulge portion 56a, and the bottom wall 53D and the top wall 53U, so that the volume of the dirty side 57 can be sufficiently obtained.

The element holder 55, which holds the element 56, is pressed by the holding tool 62 from the dirty side 57 toward the clean side 58, and thus the element 56 is held at a position that covers the opening 54a of the separate plate 54.

The element 56 overlaps the case-side opening portion 59 in the side view of the vehicle body. Therefore, it is possible to visually observe the element 56 from the case-side opening portion 59, and it is easy to check whether the element 56 is held at an appropriate position and the dirt that adheres to the surface of the element 56. In addition, it is easy to access the element 56 from the case-side opening portion 59, so replacement work of the element 56 is facilitated.

The holding tool 62 is formed by bending a metal rod into a predetermined shape. One end of the holding tool 62 is supported by the right surface, which is closer to the dirty side 57, of the air cleaner case 53. As indicated by an arrow A in FIG. 3, the holding tool 62 is rotatable in an arc, starting from one end, between a position where the element 56 is attached as indicated by a solid line and a position where the element 56 is receded and detached as indicated by a broken line. In this manner, the element 56 is easily replaced by releasing the holding tool 62. In addition, it is possible to move the holding tool 62 to a position apart from the element 56, and thus the holding tool 62 does not become a hindrance at the time of attachment and/or detachment work of the element 56, so the attachment and/or detachment work is facilitated.

The case-side opening portion 59 is formed to be large over the entire length in the longitudinal direction of the dirty side 57 of the air cleaner case 53. Therefore, as illustrated in FIGS. 2 and 5, when the holding tool 62 is rotated between the position where the element 56 is attached as indicated by the solid line and the position where the element 56 is detached as indicated by the broken line, the holding tool 62 rotates in a range that overlaps the case-side opening portion 59. Therefore, it becomes possible to visually recognize the holding tool 62 from the case-side opening portion 59 in a side view of the vehicle body, so that the person doing the replacement work easily accesses the holding tool 62, in replacing the element 56.

As illustrated in FIG. 4, the other end of the holding tool 62 is supported and fixed by a lock portion 65, which is formed on the air cleaner case 53. The lock portion 65 is provided further on the front than the element 56 in a side view of the vehicle body, and thus confirmation, attachment, or detachment of the element 56 is not inhibited by the lock portion 65 or the holding tool 62, which is locked to the lock portion 65. In addition, the other end of the holding tool 62 is bent in a substantially letter U shape to form an operation portion attachment portion 63. That is, an attachment base portion 63a, which serves as a base, and attachment wall portions 63b, which respectively extend in one direction from both ends of the attachment base portion 63a, are formed in the operation portion attachment portion 63.

The lock portion 65 includes two protrusions that extend rearward from the separate plate 54. That is, as illustrated in FIG. 4, in the lock portion 65, a space S1 is defined between the protrusions. The other end of the holding tool 62 is positioned in such a space S1, and its position is fixed by pressing and frictional force by the lock portion 65.

The holding tool 62 includes an operation portion 67, which is formed by bending a metal rod into a substantially letter U shape. The operation portion 67 serves as a handle for the person for doing the replacement work to rotate the holding tool 62 when he/she fixes and releases the element 56 using the holding tool 62.

Both end portions of the operation portion 67 each are folded into a ring shape to form a ring portion 68. The attachment base portion 63a penetrates through the ring portions 68, and then the operation portion 67 is rotatably supported by the holding tool 62. The attachment base portion 63a is formed to be slightly longer than the distance between the ring portions 68. Thus, the attachment wall portions 63b restrict the movement of the operation portion 67 in the extending direction of the attachment base portions 63a.

On the separate plate 54, two operation portion holding recess portions 54b, which are recessed from the left end to the inside in the vehicle width direction, are formed. The operation portion holding recess portions 54b accommodate the operation portion 67 when the holding tool 62 fixes the element 56. In this situation, as illustrated in FIG. 5, the operation portion 67 is disposed outside the case-side opening portion 59 in a side view of the vehicle body. In this manner, the operation portion 67 of the holding tool 62, which attaches the element 56, is positioned outside the air cleaner case 53, so an operator for doing the replacement work of the element 56 easily accesses the operation portion 67. Therefore, the operator easily detaches the element 56, and the attachment and/or detachment work is facilitated.

The separate plate 54 includes a second lock portion 66, which extends forward. The second lock portion 66 includes two protrusions that extend forward. Therefore, a space is defined near the center between the protrusions similarly to the lock portion 65. The operation portion 67 is positioned in such a space, and is fixed by the pressing and the frictional force by the second lock portion 66. An inner portion, which has a substantially letter U shape, of the operation portion 67 is accommodated and supported in the second lock portion 66.

The lock portion 65 and the second lock portion 66 each are formed on an inner side in the vehicle body width direction than an edge of the side cover 42, which is indicated by a two-dot chain line in FIG. 3. Therefore, when the side cover 42 is attached, none of the operation portion 67, the lock portion 65, or the second lock portion 66 interferes with the side cover 42, or hinders the attachment of the side cover 42.

The open surface of the operation unit holding recess portion 54b is closed by attaching the side cover 42. Therefore, when the side cover 42 is attached, the movement of the operation portion 67 is restricted. Accordingly, the holding tool 62 does not move from the position where the element 56 is attached to the position where the element 56 is detached, and the element 56 does not come off, while in driving.

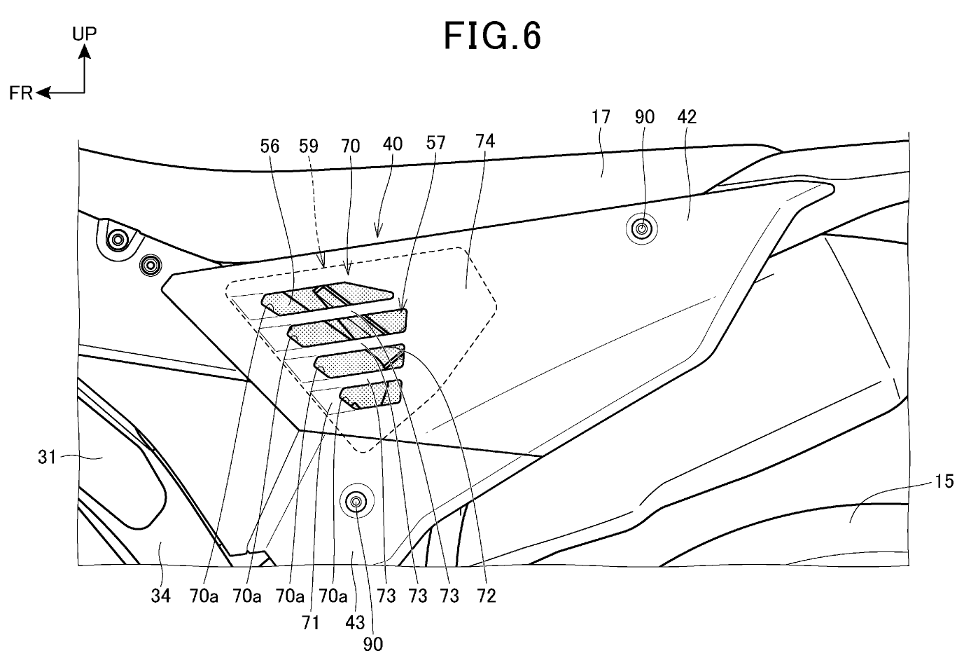

FIG. 6 is an enlarged view of a region of the side cover 42 in FIG. 1.

The case-side opening portion 59 is covered with the side cover 42.

The side cover 42 includes the cover-side opening portion 70. Cover-side openings 70a are formed in the cover-side opening portion 70. In the present embodiment, the cover-side opening portion 70 includes three reinforcement portions 73, which extend between an edge 71 on one end (front) of the cover-side opening portion 70 and an edge 72 on the other end (rear). Therefore, the cover-side opening portion 70 is divided into four cover-side openings 70a by the reinforcement portions 73.

Provision of the reinforcement portions 73 suppresses deflection of the region of the cover-side opening portion 70, and in addition, entry of foreign matters can be effectively prevented, in travelling on an off-road or the like.

Ribs that extend in the longitudinal direction of the side cover 42 are provided at upper and lower edges of the cover-side opening 70a. That is, the reinforcement portion 73 includes the rib that extends on the inner surface in the vehicle width direction, and is formed to have a letter U shape in cross-section. This further suppresses the deflection of the region of the cover-side opening portion 70, so that the strength can be improved. In addition, it is possible for the ribs to guide the flow of air entering the air cleaner device 52, so that the air can be efficiently taken into the air cleaner device 52.

An opening area of the entirety of the cover-side openings 70a as indicated by hatching in FIG. 6 is formed to be larger than an area of the element 56 as indicated by hatching in FIG. 5 in a side view of the vehicle body. Therefore, it becomes possible to sufficiently take the air into the air cleaner device 52 from the cover-side opening portion 70. As indicated by a broken line in FIG. 6, the cover-side opening portion 70 partially overlaps the element 56 in the side view of the vehicle body. Thus, it is possible to observe the contamination state on the surface of the element 56 through the opening portion 70 in a state in which the side cover 42 is attached. In addition, by detaching the side cover 42, it becomes easy to confirm or access the element 56 from a lateral side of the vehicle body through the case-side opening portion 59. Further, the edge 72 on the other end of the cover-side opening portion 70 is positioned further on the rear than the element 56 in the side view of the vehicle body. This facilitates the air to be taken into the element 56.

In addition, the side cover 42 includes a closure portion 74, which covers the case-side opening portion 59, in a rear region of the cover-side opening portion 70. In other words, the closure portion 74 faces at least a part of the case-side opening portion 59. Provision of the closure portion 74 suppresses moving out of the air that has entered the dirty side 57 of the air cleaner case 53.

In the present embodiment, the air outside the vehicle flows from the cover-side opening portion 70 of the side cover 42 into the dirty side 57 of the air cleaner case 53 through the case-side opening portion 59.

The air that has flowed into the dirty side 57 passes through the opening 54a of the separate plate 54 via the element 56, and flows into the clean side 58. A funnel 61 is disposed in the clean side 58, and the air in the clean side 58 flows into a throttle body 51 through the funnel 61.

For example, with regard to a racing vehicle, while the vehicle is traveling, a rider sits near a front part of the seat 17, or stands on the steps 18 in some cases. In such cases, the rider’s legs are placed on the front of the side covers 42. Therefore, the cover-side opening portion 70 of the side cover 42 is positioned on the rear of the rider’s leg.

Therefore, for example, the traveling wind that passes through lateral sides of the vehicle body passes through the outside of the rider’s legs, is then brought into the inside, and flows into the center of the vehicle body. Since the cover-side opening 70a, which serves as the air intake opening of the side cover 42, is open on the rear of the rider’s leg, such traveling air to be brought into easily passes through the cover-side opening portion 70 and the case-side opening portion 59, and enters the inside of the air cleaner case 53. Then, the air that has entered the air cleaner case 53 easily moves rearward in the air cleaner case 53 by inertia. Therefore, provision of a seal between the case-side opening portion 59 and the side cover 42 suppresses the air that has entered the inside of the air cleaner case 53 moving out of the air cleaner case 53.

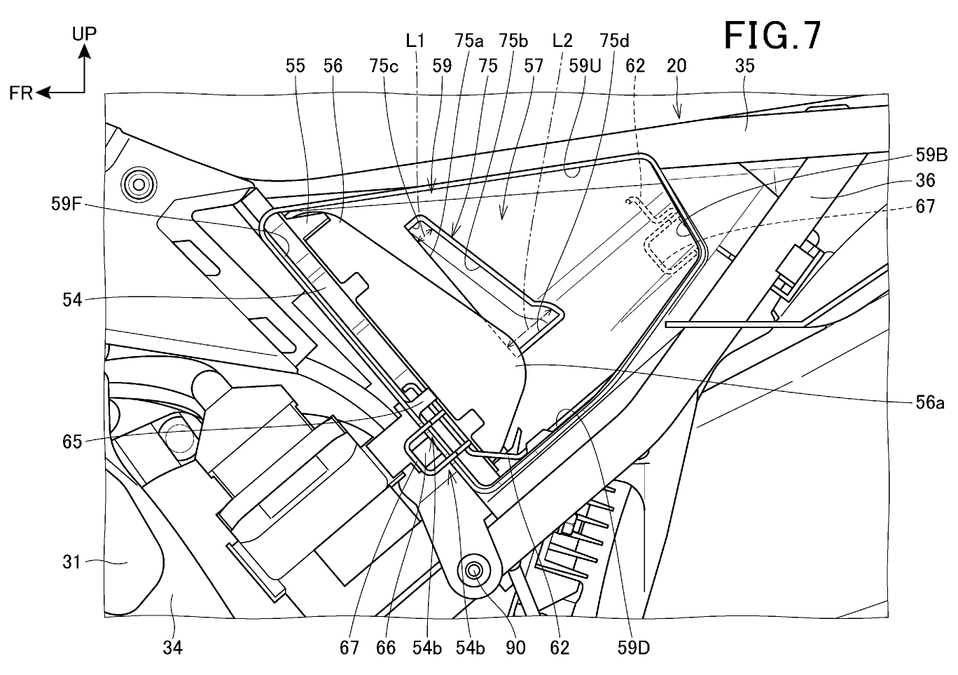

FIG. 7 is an enlarged view of main components of FIG. 2.

The auxiliary intake opening portion 75 is formed on a right surface of the dirty side 57 of the air cleaner case 53. The auxiliary intake opening portion 75 is disposed at a position in close proximity to the element 56 in a side view of the vehicle body, and partially overlaps the bulge portion 56a of the element 56. Thus, the flow of intake air from the auxiliary intake opening portion 75 to the element 56 does not inhibit the flow of intake air from the case-side opening portion 59 to the element 56, that is, while smoothly maintaining the flow of the intake air from the case-side opening portion 59 to the element 56, it becomes possible to take in outside air also from the auxiliary intake opening portion 75, and air intake efficiency is improved.

The auxiliary intake opening portion 75 is a substantially trapezoidal hole in the side view of the vehicle body. The auxiliary intake opening portion 75 includes: a first opening edge 75a, which is close to the element 56 (a front end), of the auxiliary intake opening portion 75; and a second opening edge 75b, which is far from the element 56 (a rear end), of the auxiliary intake opening portion 75. The second opening edge 75b extends along the element 56. The first opening edge 75a extends obliquely with respect to the second opening edge 75b in the side view of the vehicle body, and is formed in a shape in which a separation distance between the first opening edge 75a and the second opening edge 75b gradually increases toward the rear of the vehicle body. Thus, a length L1 in the front-rear direction in an upper portion of the auxiliary intake opening portion 75 is shorter than a length L2 in the front-rear direction in a lower portion of the auxiliary intake opening portion 75.

In the present embodiment, the auxiliary intake opening portion 75 includes: a third opening edge 75c, which connects an upper end of the first opening edge 75a with an upper end of the second opening edge 75b; and a fourth opening edge 75d, which connects a lower end of the first opening edge 75a with a lower end of the second opening edge 75b. In the side view of the vehicle body, the length between the first opening edge 75a and the second opening edge 75b gradually increases from the third opening edge 75c to the fourth opening edge 75d. That is, the length of the fourth opening edge 75d is longer than that of the third opening edge 75c.

In this manner, the second opening edge 75b has a shape corresponding to the outer peripheral shape of the element 56, and is disposed on the rear of the surface of the element 56 with a predetermined space, and thus the air that has been taken in from a right lateral side of the vehicle body turns to the front, and is easily taken into the element 56. In addition, the area of the auxiliary intake opening portion gradually increases toward the vicinity of the bulge portion 56a, which has a large surface area of the element 56, so the air is easily taken into the element 56. Therefore, it becomes possible to efficiently take the air into the element 56, so that the air intake efficiency can be improved.

FIG. 8 is a perspective view illustrating a right surface of the air cleaner case 53 together with a peripheral configuration.

The auxiliary intake opening portion 75 is covered with a guide wall 76, which is provided on the right surface of the air cleaner case 53. The guide wall 76 includes: a guide wall right wall 77, which extends along the right surface of the air cleaner case 53; a guide wall rear wall 78, which extends obliquely rearward from a rear end of the guide wall right wall 77; a guide wall top surface 79, which extends from an upper end of the guide wall right wall 77 to the right surface of the air cleaner case 53; and a guide wall bottom surface 80, which extends from a lower end of the guide wall right wall 77 to the right surface of the air cleaner case 53.

Therefore, the respective walls 77, 78, 79, and 80 of the guide wall 76 and the right surface of the air cleaner case 53 form a duct portion 85, which serves as a flow passage of outside air toward the auxiliary intake opening portion 75. A front side of the duct portion 85 in the vehicle body is open, and an air introduction port 81, which introduces outside air from the front of the vehicle body, is formed. That is, when the saddle-ride vehicle 10 travels or the like, outside air is taken in from the air introduction port 81, and is guided by the duct portion 85 to the auxiliary intake opening portion 75.

In addition, the guide wall 76 includes a joint portion 82, which extends along the right surface of the air cleaner case 53, and abuts the right surface of the air cleaner case 53. In the present embodiment, fastening members 83 penetrate through the joint portion 82 and the right surface of the air cleaner case 53, and nut members, not illustrated, are respectively fastened to the fastening members 83 from the outside of the vehicle, and thus the guide wall 76 is fixed to the right surface of the air cleaner case 53. Note that as a fixing structure of the joint portion 82 to the air cleaner case 53, a fixing structure such as caulking, press-fitting, or welding is applicable.

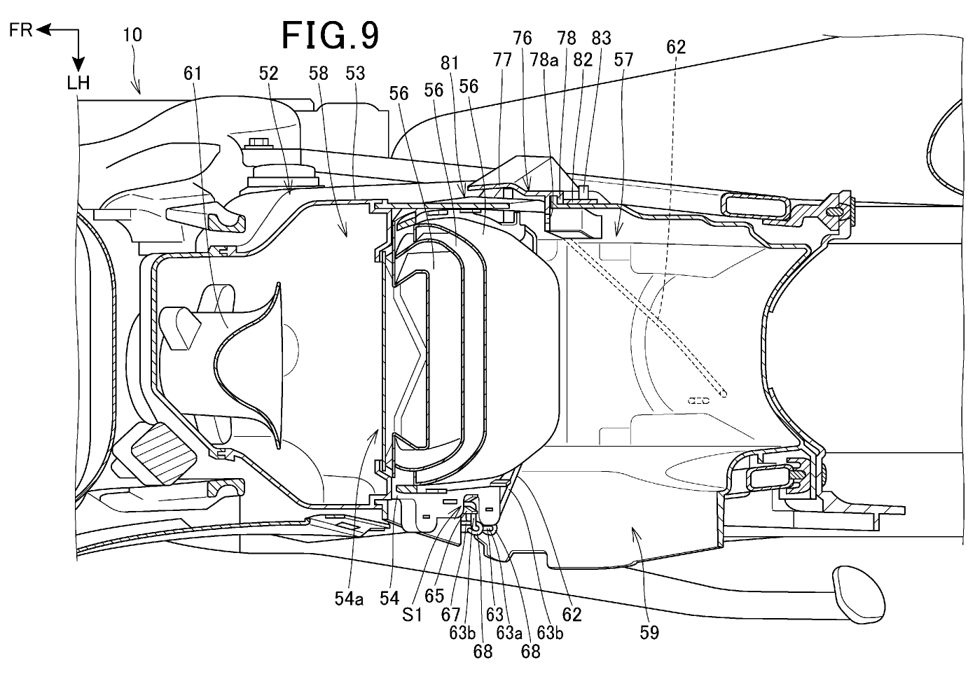

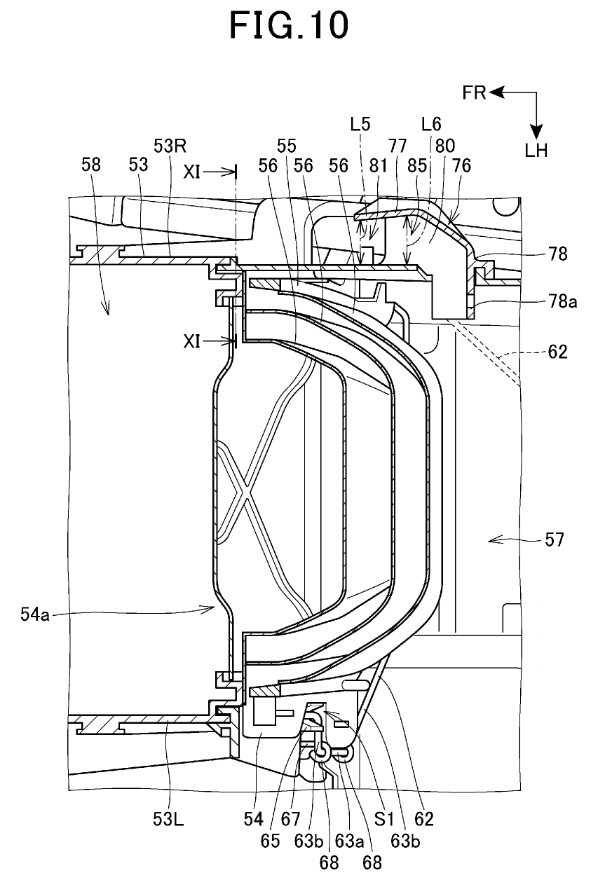

FIG. 9 is a cross-sectional view taken along line IX-IX of FIG. 5. FIG. 10 is an enlarged view of the periphery of the element 56 in FIG. 9.

The guide wall rear wall 78 extends from the outside of the air cleaner case 53 to the inside of the air cleaner case 53. An air cleaner case inner portion 78a of the guide wall rear wall 78 extends toward the element 56. In this manner, the guide wall 76 enables outside air to efficiently flow into the auxiliary intake opening portion 75. In addition, a part of the guide wall 76 is directed toward the element 56, so that outside air can be guided toward the element 56, which is advantageous for improving the air intake efficiency.

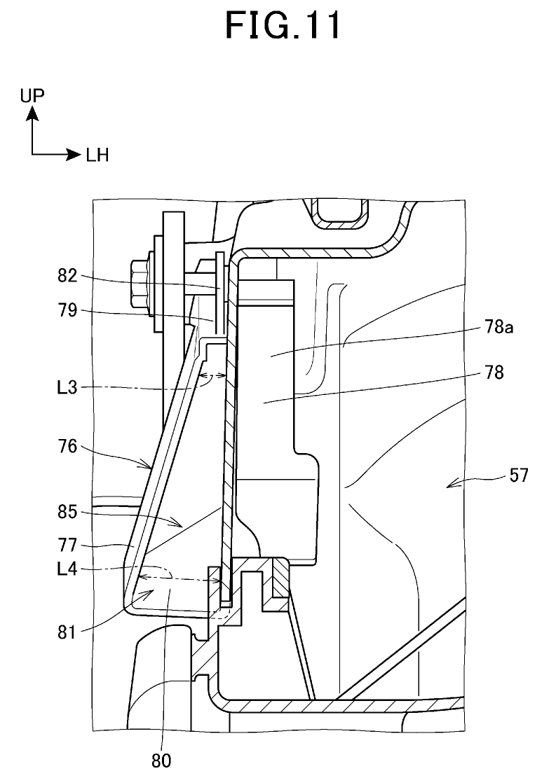

FIG. 11 is a cross-sectional view taken along line XI-XI of FIG. 10.

The air introduction port 81 of the guide wall 76 is an opening having a substantially trapezoidal shape in a front view of the vehicle body. Specifically, the length of the air introduction port 81 of the guide wall 76 in the left-right direction is defined to correspond to the auxiliary intake opening portion 75.

In the present embodiment, as illustrated in FIG. 7, the length L1 in the front-rear direction in the upper portion of the auxiliary intake opening portion 75 is shorter than the length L2 in the front-rear direction in the lower portion of the auxiliary intake opening portion 75. Therefore, a length L3 in the left-right direction in an upper portion of the air introduction port 81 of the guide wall 76 is shorter than a length L4 in the left-right direction in a lower portion of the air introduction port 81 of the guide wall 76. In this manner, the length in the left-right direction of the air introduction port 81 of the guide wall 76 is defined to correspond to the length in the front-rear direction of the auxiliary intake opening portion 75.

In the present embodiment, as described above, the air introduction port 81 expands in the vehicle width direction toward its bottom. In other words, the vehicle body width is narrowed toward the top of the air cleaner case 53. Therefore, it is advantageous to improve the foot grounding property of the occupant.

In addition, the guide wall right wall 77 is in closer proximity to the right surface of the air cleaner case 53 toward the front of the vehicle body in a top view of the vehicle body. Thus, as illustrated in FIG. 10, a length L5 in the left-right direction in the front portion of the duct portion 85 is shorter than a length L6 in the left-right direction in the rear portion of the duct portion 85. That is, the duct portion 85 diminishes toward the upstream (front) side, and is formed so that the flow passage of outside air is narrowed. In this manner, the upstream side of the duct portion 85 is narrower than the downstream side, so that entry of foreign matters from the air introduction port 81 can be suppressed, in travelling on an off-road or the like.

The guide wall bottom surface 80 is inclined downward toward the front of the vehicle body. In other words, the bottom surface of the duct portion 85 is inclined downward. Thus, even though rainwater or the like enters from the air introduction port 81, the rainwater or the like is easily guided and discharged to the outside of the air cleaner device 52 by the duct portion 85, so that the entry of water into the air cleaner device 52 can be suppressed.

As described heretofore, in the saddle-ride vehicle 10 including the air cleaner device 52, which constitutes a part of the power unit intake system, the side cover 42, which covers at least a part of the air cleaner device 52 from one side in the vehicle width direction, is included. The air cleaner device 52 includes: the air cleaner case 53, the inside of which is hollow; and the element 56, which is disposed in the air cleaner case 53. The case-side opening portion 59, which opens a space on an air intake side of the element 56, is provided on the side wall on one side in the vehicle width direction of the air cleaner case 53, the side cover 42 includes the cover-side opening portion 70, which faces at least a part of the case-side opening portion 59, and the rear region of the cover-side opening portion 70 serves as the closure portion 74, which faces at least a part of the case-side opening portion 59.

According to this configuration, the air outside the vehicle can be efficiently taken into the air cleaner case 53 from the cover-side opening portion 70 of the side cover 42 through the case-side opening portion 59. In addition, by detaching the side cover 42, it becomes easy to confirm or access the element 56 from a lateral side of the vehicle body through the case-side opening portion 59. Therefore, it becomes possible to improve maintenance capability of the air cleaner device 52 while efficiently taking outside air into the air cleaner device 52.

In the side view of the vehicle body, the opening area of the cover-side opening portion 70 is larger than the area of the element 56 in the side view of the vehicle body, and the cover-side opening portion 70 includes the reinforcement portion 73, which traverses the opening region.

According to this configuration, since the opening area of the cover-side opening portion 70 is larger than the area of the element 56 in the side view of the vehicle body, it becomes possible to sufficiently take the air into the air cleaner device 52. In addition, the reinforcement portion 73 suppresses the deflection of the region of the cover-side opening portion 70, and in addition, entry of foreign matters can be effectively prevented, in travelling on an off-road or the like.

The element 56 is disposed at a position further apart forward than the rear end portion of the air cleaner case 53, and includes the bulge portion 56a, which bulges toward the rear end portion of the air cleaner case 53.

According to this configuration, it becomes possible to ensure the volume of the dirty side 57, which constitutes a space on the air intake side of the element 56, and in addition, it becomes possible to increase the volume and surface area of the element 56 while maintaining a sufficient space around the element 56.

The holding tool 62, which fixes the element 56 to the air cleaner case 53, and the operation portion 67, which fixes and releases the element 56 using the holding tool 62 are included. The operation portion 67 is disposed outside the case-side opening portion 59 in a side view of the vehicle body.

According to this configuration, since the operation portion 67 is positioned outside the air cleaner case 53, the operator for doing the replacement work of the element 56 easily accesses the operation portion 67. Therefore, the operator easily moves the holding tool 62, and the attachment and/or detachment work of the element 56 is facilitated.

The holding tool 62 is movable inside the air cleaner case 53 between a position of fixing the element 56 and a position of receding from the element 56, and is provided at a position of overlapping the case-side opening portion 59 in the side view of the vehicle body.

According to this configuration, since the holding tool 62 is visually observable from the case-side opening portion 59 in the side view of the vehicle body, it is easy to access the holding tool 62, so that the attachment and/or detachment work of the element 56 is facilitated.

The auxiliary intake opening portion 75, which opens a space on an air intake side of the element 56, is defined on another side in the vehicle width direction of the air cleaner case 53. In the side view of the vehicle body, the auxiliary intake opening portion 75 includes: the first opening edge 75a on a side close to the element 56; and the second opening edge 75b on a side far from the element 56, the second opening edge 75b is formed in a shape that extends along the outer shape of the element 56 in the side view of the vehicle body, the first opening edge 75a is formed in a shape in which the separation distance between the first opening edge 75a and the second opening edge 75b gradually increases toward the rear of the vehicle body in the side view of the vehicle body, and the auxiliary intake opening portion 75 partially overlaps the element 56 in the side view of the vehicle body.

According to this configuration, the auxiliary intake opening portion 75 is provided on the opposite side of the case-side opening portion 59 with respect to the element 56, so that it becomes possible to improve the air intake efficiency by taking in the air also from the auxiliary intake opening portion 75 while suppressing the influence on the flow of the intake air from the case-side opening portion 59. In addition, with the above shape and arrangement of the auxiliary intake opening portion 75, it becomes possible to efficiently take the air into the element 56. This also enables improvement in the air intake efficiency.

The air cleaner case 53 includes the guide wall 76, which covers the outside of the auxiliary intake opening portion 75, the guide wall 76 forms the duct portion 85, which guides outside air to the auxiliary intake opening portion 75, and a part of the guide wall 76 is directed toward the element 56.

According to this configuration, outside air can be made to efficiently flow into the auxiliary intake opening portion 75. In addition, since a part of the guide wall 76 is directed toward the element 56, outside air can be made to flow toward the element 56, which is advantageous for improving the air intake efficiency.

The air introduction port 81, for introducing outside air, of the duct portion 85 expands outward in the vehicle width direction toward the bottom of the air introduction port 81.

According to this configuration, the air can be efficiently introduced by the air introduction port 81. In addition, since the air introduction port 81 expands outward in the vehicle width direction toward the bottom of the air introduction port 81, the width of the air cleaner case 53 can be narrowed toward its top, so that the width size of the vehicle body can be narrowed upward, which is advantageous for improving the foot grounding property of the occupant.

The duct portion 85 is narrowed forward in a top view of the vehicle body, and the bottom surface of the duct portion 85 is inclined upstream and downward.

According to this configuration, since a vertical length is narrowed in an upstream end of the air introduction port 81 and its periphery, entry of foreign matters can be suppressed, in travelling on an off-road or the like. Further, the bottom surface of the air introduction port 81 is inclined upstream and downward, so that rainwater or the like can be discharged even though it enters.

### Other Embodiments

The above-described embodiments are merely an aspect of the present invention, and can be optionally modified and applied within a scope that does not depart from the gist of the present invention.

In the above-described embodiment, description has been made with regard to an example in which the case-side opening portion 59 is provided on the left of the air cleaner case 53 and the auxiliary intake opening portion 75 is provided on the right of the air cleaner case 53. However, the case-side opening portion 59 may be provided on the right of the air cleaner case 53, and the auxiliary intake opening portion 75 may be provided on the left of the air cleaner case 53.

In the above-described embodiment, description has been made with regard to an example in which the length L1 in the front-rear direction in the upper portion of the auxiliary intake opening portion 75 is shorter than the length L2 in the front-rear direction in the lower portion of the auxiliary intake opening portion 75. However, the length L1 in the front-rear direction in the upper portion of the auxiliary intake opening portion 75 may be longer than the length L2 in the front-rear direction in the lower portion of the auxiliary intake opening portion 75. In this case, the length L3 in the left-right direction in the upper portion of the air introduction port 81 is preferably longer than the length L4 in the left-right direction in the lower portion of the air introduction port 81 of the guide wall 76.

In the above-described embodiment, description has been made with regard to an example in which a seal is provided on an edge of the case-side opening portion 59. However, instead of the edge of the case-side opening portion 59, the seal may be provided on an inner surface in the vehicle width direction of the side cover 42 to correspond to the edge of the case-side opening portion 59. In addition, seals may be provided on both the edge of the case-side opening portion 59 and the side cover 42.

Further, the seal may not be necessarily provided on the entire circumference of the edge of the case-side opening portion 59. For example, at least a part of the seal may be disposed to correspond to the edge of the case-side opening portion 59 on the rear of the cover-side opening 70a of the side cover 42.

### Configurations Supported by Above Embodiments

The above embodiments support the following configurations.

(Configuration 1) A saddle-ride vehicle includes: an air cleaner device, which constitutes a part of a power unit intake system; and a side cover, which covers at least a part of the air cleaner device from one side in a vehicle width direction, in which the air cleaner device includes: a case, inside of which is hollow; and an element disposed in the case, and a case-side opening portion, which opens a space on an air intake side of the element, is provided on a side wall on one side in the vehicle width direction of the case, and the side cover includes a cover-side opening portion, which faces at least a part of the case-side opening portion, and a rear region of the cover-side opening portion serves as a closure portion, which faces at least a part of the case-side opening portion.

According to this configuration, the air outside the vehicle can be efficiently taken into the case from the cover-side opening portion of the side cover through the case-side opening portion. In addition, by detaching the side cover, it becomes easy to confirm or access the element from a lateral side of the vehicle body through the case-side opening portion. Therefore, it becomes possible to improve maintenance capability of the air cleaner device while efficiently taking outside air into the air cleaner device.

(Configuration 2) The saddle-ride vehicle according to the configuration 1, in which in a side view of a vehicle body, an opening area of the cover-side opening portion is larger than an area of the element in the side view of the vehicle body, and the cover-side opening portion includes a reinforcement portion, which traverses an opening region.

According to this configuration, since the opening area of the cover-side opening portion is larger than the area of the element in the side view of the vehicle body, it becomes possible to sufficiently take the air into the air cleaner device. In addition, the reinforcement portion suppresses the deflection of the region of the cover-side opening portion, and in addition, entry of foreign matters can be effectively prevented, in travelling on an off-road or the like.

(Configuration 3) The saddle-ride vehicle according to the configuration 1 or 2, in which the element is disposed at a position further apart forward than a rear end portion of the case, and includes a bulge portion, which bulges toward a rear end portion of the case.

According to this configuration, it becomes possible to ensure the volume of the dirty side, which constitutes a space on the air intake side of the element, and in addition, it becomes possible to increase the volume and surface area of the element while maintaining a sufficient space around the element.

(Configuration 4) The saddle-ride vehicle according to one of the configurations 1 to 3, further includes: a holding tool, which fixes the element to the case; and an operation portion, which fixes and releases the element using the holding tool, in which the operation portion is disposed outside the case-side opening portion in a side view of a vehicle body.

According to this configuration, since the operation portion is positioned outside the air cleaner case, the operator for doing the replacement work easily accesses the operation portion. Therefore, the operator easily moves the holding tool, and the attachment and/or detachment work is facilitated.

(Configuration 5) The saddle-ride vehicle according to the configuration 4, in which the holding tool is movable inside the case between a position of fixing the element and a position of receding from the element, and is provided at a position of overlapping the case-side opening portion in the side view of the vehicle body.

According to this configuration, since the holding tool is visually observable from the case-side opening portion in the side view of the vehicle body, it is easy to access the holding tool, so that the attachment and/or detachment work of the element is facilitated.

(Configuration 6) The saddle-ride vehicle according to one of the configurations 1 to 5, in which an auxiliary intake opening portion, which opens the space on the air intake side of the element, is defined on another side in the vehicle width direction of the case, in a side view of a vehicle body, the auxiliary intake opening portion includes: a first opening edge on a side close to the element; and a second opening edge on a side far from the element, the second opening edge is formed in a shape that extends along an outer shape of the element in the side view of the vehicle body, the first opening edge is formed in a shape in which a separation distance between the first opening edge and the second opening edge gradually increases toward rear of the vehicle body in the side view of the vehicle body, and the auxiliary intake opening portion partially overlaps the element in the side view of the vehicle body.

According to this configuration, the auxiliary intake opening portion is provided on the opposite side of the case-side opening portion with respect to the element, so that it becomes possible to improve the air intake efficiency by taking in the air also from the auxiliary intake opening portion while suppressing the influence on the flow of the intake air from the case-side opening portion. In addition, with the above shape and arrangement of the auxiliary intake opening portion, it becomes possible to efficiently take the air into the element. This also enables improvement in the air intake efficiency.

(Configuration 7) The saddle-ride vehicle according to the configuration 6, in which the case includes a guide wall, which covers an outside of the auxiliary intake opening portion, the guide wall forms a duct portion, which guides outside air to the auxiliary intake opening portion, and a part of the guide wall is directed toward the element.

According to this configuration, outside air can be made to efficiently flow into the auxiliary intake opening portion. In addition, since a part of the guide wall is directed toward the element, outside air can be made to flow toward the element, which is advantageous for improving the air intake efficiency.

(Configuration 8) The saddle-ride vehicle according to the configuration 7, in which an air introduction port, for introducing outside air, of the duct portion expands outward in the vehicle width direction toward a bottom of the air introduction port.

According to this configuration, the air can be efficiently introduced by the air introduction port. In addition, since the air introduction port expands outward in the vehicle width direction toward its bottom, the width of the air cleaner case can be narrowed toward its top, so that the width size of the vehicle body can be narrowed upward, which is advantageous for improving the foot grounding property of the occupant.

(Configuration 9) The saddle-ride vehicle according to the configuration 7 or 8, in which the duct portion is narrowed forward in a top view of the vehicle body, and a bottom surface of the duct portion is inclined upstream and downward.

According to this configuration, since a vertical length is narrowed in an upstream end of the air introduction port and its periphery, entry of foreign matters can be suppressed, in travelling on an off-road or the like. Further, the bottom surface of the air introduction port is inclined upstream and downward, so that rainwater or the like can be discharged even though it enters.

### REFERENCE SIGNS LIST

10 Saddle-type vehicle
42 Side cover
52 Air cleaner device
53 Air cleaner case (case)
56 Element
56a Bulge portion
59 Case-side opening portion
62 Holding tool
67 Operation portion
70 Cover-side opening portion
73 Reinforcement portion
74 Closure portion
75 Auxiliary intake opening portion
75a First opening edge
75b Second opening edge
76 Guide wall
81 Air introduction port
85 Duct portion

What is claimed is:

1. A saddle-ride vehicle comprising:
an air cleaner device, which constitutes a part of a power unit intake system; and
a side cover, which covers at least a part of the air cleaner device from one side in a vehicle width direction, wherein
the air cleaner device includes: a case, inside of which is hollow; and an element disposed in the case, and a case-side opening portion, which opens a space on an air intake side of the element, is provided on a side wall on one side in the vehicle width direction of the case, and
the side cover includes a cover-side opening portion, which faces at least a part of the case-side opening portion, and a rear region of the cover-side opening portion serves as a closure portion, which faces at least a part of the case-side opening portion.

2. The saddle-ride vehicle according to claim 1, wherein
in a side view of a vehicle body, an opening area of the cover-side opening portion is larger than an area of the element in the side view of the vehicle body, and
the cover-side opening portion includes a reinforcement portion, which traverses an opening region.

3. The saddle-ride vehicle according to claim 1, wherein
the element is disposed at a position further apart forward than a rear end portion of the case, and includes a bulge portion, which bulges toward a rear end portion of the case.

4. The saddle-ride vehicle according to claim 1, further comprising:
a holding tool, which fixes the element to the case; and
an operation portion, which fixes and releases the element using the holding tool, wherein
the operation portion is disposed outside the case-side opening portion in a side view of a vehicle body.

5. The saddle-ride vehicle according to claim 4, wherein,
the holding tool is movable inside the case between a position of fixing the element and a position of receding from the element, and is provided at a position of overlapping the case-side opening portion in the side view of the vehicle body.

6. The saddle-ride vehicle according to claim 1, wherein
an auxiliary intake opening portion, which opens the space on the air intake side of the element, is defined on another side in the vehicle width direction of the case,
in a side view of a vehicle body, the auxiliary intake opening portion includes: a first opening edge on a side close to the element; and a second opening edge on a side far from the element,
the second opening edge is formed in a shape that extends along an outer shape of the element in the side view of the vehicle body,
the first opening edge is formed in a shape in which a separation distance between the first opening edge and the second opening edge gradually increases toward rear of the vehicle body in the side view of the vehicle body, and
the auxiliary intake opening portion partially overlaps the element in the side view of the vehicle body.

7. The saddle-ride vehicle according to claim 6, wherein
the case includes a guide wall, which covers an outside of the auxiliary intake opening portion,
the guide wall forms a duct portion, which guides outside air to the auxiliary intake opening portion, and
a part of the guide wall is directed toward the element.

8. The saddle-ride vehicle according to claim 7, wherein
an air introduction port, for introducing outside air, of the duct portion expands outward in the vehicle width direction toward a bottom of the air introduction port.

9. The saddle-ride vehicle according to claim 8, wherein
the duct portion is narrowed forward in a top view of the vehicle body, and
a bottom surface of the duct portion is inclined upstream and downward.
